(19) United States
(12) Patent Application Publication
(10) Pub. No.: US 2017/0149719 A1
(43) Pub. Date: May 25, 2017

(54) METHOD FOR PROVIDING SOCIAL NETWORK SERVICE WITH DUAL ACCOUNTS OF INTEREST AND IDENTIFICATION

(71) Applicant: Sungyoung Yeh, Seoul (KR)

(72) Inventor: Sungyoung Yeh, Seoul (KR)

(21) Appl. No.: 14/946,567

(22) Filed: Nov. 19, 2015

(51) Int. Cl. H04L 12/58; H04L 29/08

(52) U.S. Cl. CPC H04L 51/32; H04L 67/26; H04L 67/22; G06Q 50/01

(57) ABSTRACT

Provided is a method for providing a social network service in which an interest account and a human account are dualized. The method includes logging in, by a user terminal P, through a pre-registered unique account (defined as a “human account”) when subscribing a social network service platform, and generating one or more interest accounts, and networking, by the platform server, a platform accessed by the user terminal P by separating the human account from the interest account (—a friend relationship by the human account is independent from a friend relationship by the interest account), wherein when the user terminal P performs an upload event to the platform through the interest account, the platform diffuses the upload event to another user terminal Q2 of which a friend relationship is set through the interest account.

### BACKGROUND

The present disclosure relates to a method for providing a social network service, and more particularly, to a method for mutually networking content and data using a user account.

A social network in a social network service (SNS) carries out networking for numerous people with a connection link called friend relationship. A system at this point is a huge people-centric group. Such a social network is also a virtual world group in which mutual exchange is continued online on the basis of offline relations in an area, school, and workplace. As active exchanges are performed online among people, the social network holds a place deep in our lives and also becomes another living space. Facebook™, which is most universally used nowadays among social network services, functions as a huge online platform that delivers information among friends.

This huge platform is in the middle of evolution. Beyond simple exchange of information, it is used as a new marketing space in which various pieces of content and commercial information may be shared. It is an evolution to a so-called social business platform. The social business platform uses relations that are intertwined like a web among numerous people in the social network service. This platform naturally diffuses information such as advertisement according to a connection link called friend relationship.

However, it is not easy that the current social network completely evolves to the social business platform. The social network service is based on a people-centric network from the beginning. Since the current social network is used as a forum for human interaction for communicating information among friends, users thereof feel uncomfortable that commercial information penetrates into that space and is overused. In particular, modern people just feel bothersome about undesired commercial information that is unnecessarily delivered. When the commercial information is spread using the connection link of friend relationship in the social network, this commercial information may be delivered even to people that do not want it, cause resistance of the people, and may have a negative effect on an existing network.

In addition, since users set as “fried relationship” have difference in tendency, interest, or preference, etc., there are many cases where users do not want articles posted by themselves to be spread to all other users in friend relationship. Briefly, information is “just scanned but not shared”. Due to this reason, the social business platform based on the social network service does not achieve results as expected.

In the specification, “Facebook” is assumed to be a representative platform of existing techniques. In this platform, a grouping concept is introduced. It is a tool for allowing meetings or groups of users to be freely generated online like an offline meeting. However, since being excessively exclusive, a network constructed using the grouping is difficult to evolve to a business platform in that the network only includes the small number of people, existence of that group is not diffused through the network, and not all users subscribed to the group voluntarily carry out the subscription.

The inventors of the present disclosure have researched for a long time to fundamentally address the above-described limitations and finally completed the present disclosure.

### SUMMARY

The present disclosure provides a method for integrating a people-centric network, which is a feature of an existing SNS, into an interest-centric network, while the people-centric network is maintained, in order to actively reflect various interests of users in the networks.

The present disclosure also provides an opportunity and means for acting on a network without reading mind of another person who is in a friend relationship by reflecting mentality of a user in using an SNS and acting on an SNS platform.

The present disclosure also provides a new method for developing an SNS to a social business platform. Accurate information on propensities or interests of consumers is necessary to successfully evolve to the social business platform. It is not until such information is used that commercial content may be properly diffused and target marketing becomes possible. The present disclosure also provides a platform technique capable of accurately obtaining such information.

Besides, other objectives that are not specified in the present disclosure are additionally considered within the scope of the detailed description and advantageous effects.

In accordance with an exemplary embodiment of the present invention, a method is provided which provides a social network service in which an interest account and a human account are dualized. The method includes: (a) logging in, by a user terminal P, through a pre-registered unique account (defined as a “human account”) when subscribing a social network service platform, and generating one or more interest accounts; (b) networking, by the platform server, a platform accessed by the user terminal P by separating the human account from the interest account (—a friend relationship by the human account is independent from a friend relationship by the interest account); and (c-1) when the user terminal P performs an upload event to the platform through the interest account, diffusing, by the platform, the upload event to another user terminal Q2 of which a friend relationship is set through the interest account; or (c-2) when the user terminal P performs an upload event to the platform with the human account, diffusing, by the platform, the upload event to another user terminal Q1 of which a friend relationship is set through the human account.

The method may further include selectively logging in, by the user terminal P, through any one of the human account and the interest account.

In a case of logging in through the human account, a user page of the user terminal P may include both of networking information on the human account and networking information on the interest account, and in a case of logging in through the interest account, the user page of the user terminal P may include only networking information on a corresponding interest account.

The generation of the interest account in operation (a) may further include: inputting, by the user terminal P, an interest keyword; and presenting, by the platform server, one or more recommended interest keywords associated with the interest keyword input to the user terminal P.

The method may further include presenting, by the platform server, information on other user terminals Q1 and Q2 that register, as accounts, interests identical to or associated with the interest account, when the user terminal P completes the generation of the interest account.

Operation (b) may include distinguishing the human account from the interest account and calling when an article located in another network is called using an application programming interface (API).

The update event may be one of the following: (1) uploading text to a page of the user terminal P; (2) uploading a still image or video to a page of the user terminal P; (3) uploading a response action on networking information on the user terminal P; (4) uploading to link an article located in another network to the user terminal P; and (5) updating registered information on the user terminal P.

When the platform server pushes one or more pieces of information from the platform to user terminals, the platform server may distinguish the human account from the interest account of the user terminal P and separately pushes the information.

### BRIEF DESCRIPTION OF THE DRAWINGS

Exemplary embodiments can be understood in more detail from the following description taken in conjunction with the accompanying drawings, in which:

FIG. 1 illustrates an exemplary networking by multi-accounts (i.e. human account and interest account) of a social network service (SNS) according to an embodiment of the present disclosure;

FIG. 2 is a simplified view of FIG. 1;

FIG. 3 is a schematic view of an exemplary configuration of an SNS system where a human account and an interest account are dualized;

FIG. 4A illustrates an example of a state where networking is carried out with a human account, and FIG. 4B illustrates an example of a state where networking is carried out with an interest account in an SNS system;

FIG. 5A illustrates a user page of a human account, and FIG. 5B is a view that a screen configuration of a user page of an interest account X₁ is simplified;

FIG. 6 is a view illustrating a scenario for calling a network according to an embodiment of the present disclosure with an API in a article page existing in an external network; and

FIG. 7 schematically illustrates an overall process of a method according to an embodiment of the present disclosure.

The accompanying drawings are included to provide a further understanding of the inventive concept, and the scope of the right of the present disclosure is not limited thereto.

### DETAILED DESCRIPTION OF EMBODIMENTS

Hereinafter, specific embodiments will be described in detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present invention to those skilled in the art. In the following description, detailed descriptions of well-known functions or constructions will be omitted since they would obscure the invention in unnecessary detail.

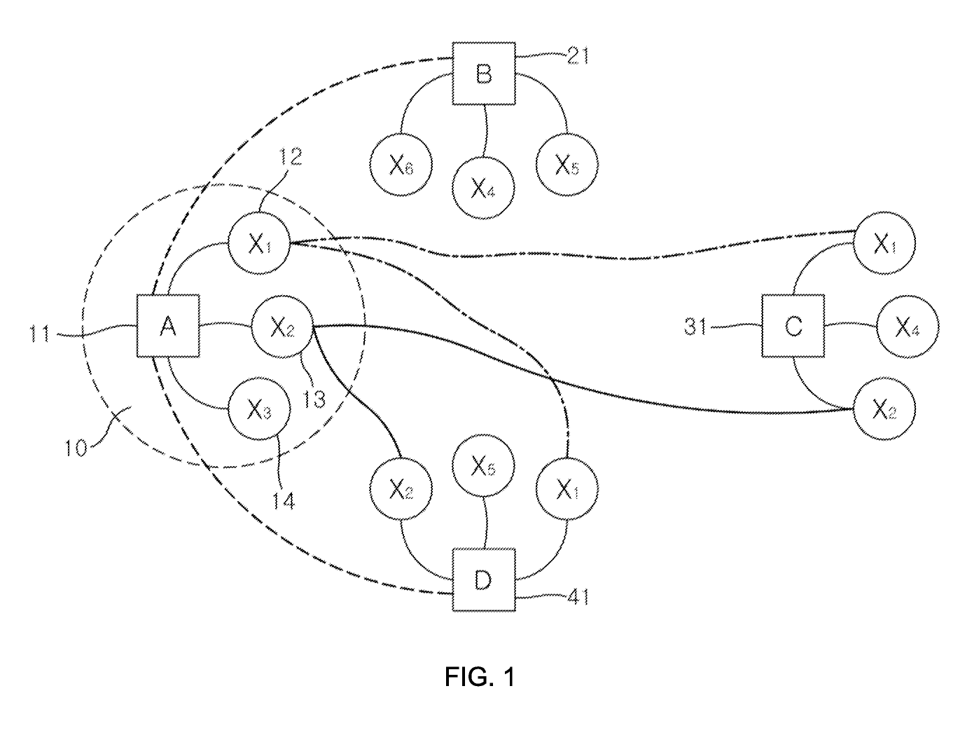

FIG. 1 schematically illustrates a configuration of a networking method according to an embodiment of the present disclosure. FIG. 1 illustrates an aspect of 4 users networking online (including through a mobile terminal) on a platform of an embodiment of the present disclosure. The users may have multi-accounts.

The user holds a status of a user terminal in a network. A user account 10 is used for entering a network system by the user terminal. The user account 10 includes a unique default account 11 registered when subscribing to the network system. Since being uniquely assigned to each terminal, the default account is defined as a “human account” for convenience in the specification. The user terminal in the present disclosure may generate one or more interest accounts 12, 13, and 14 besides the human account 11. The interest account is not a tag or page in which an interest is registered, but an “account”. Since the interest account is an account for uniquely specifying a user as a network element, an ID for notifying the interest account is separately given. In addition, the user may login to the network with this interest account 12, 13, or 14.

In particular, a separate networking may be carried out using the interest account 12, 13, or 14 which is distinguished from the human account 11. That is, an interest network is constructed. The user terminal voluntarily generates the interest account. In addition, the user terminal builds a friend relationship on the interest network using the interest account, and transmits and receives content and information. This network becomes active due to “interest matching”. Moreover, since the interest account is separated from the human account 11 that is a default account, “an online behavior related to the interest may be concealed” among friends of the interest account. The interest network may protect mentality of the user.

FIG. 1 is referred to again. The human account 11 (i.e. a user terminal A) is in a friend relationship with a human account 21 (i.e. a user terminal B) and a human account 41 (i.e.

a user terminal D), but is not in a friend relationship with a human account 41 (i.e. a user terminal C). The user terminal A generates three interest accounts 12, 13, and 14. A separate friend relationship may be built by the interest account 12. For example, the user terminal A and user terminal C are not in a friend relationship by the default accounts. However, for an interest represented as “X₁” and an interest represented as “X₂”, the user terminals A and C are in a friend relationship and are networked.

The user terminals A and B are in a friend relationship by default accounts (i.e. human accounts), but are not networked through an interest. In other words, interests thereof are different from each other. On the other hand, the user terminal A and a user terminal D are in a friend relationship by default accounts and are also networked through an interest.

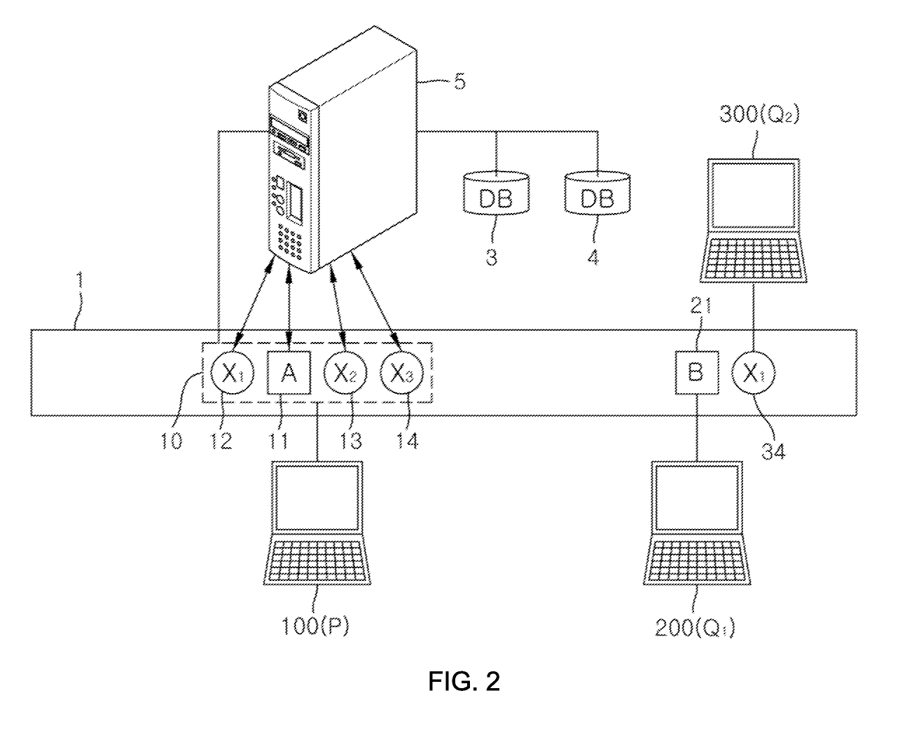

FIG. 2 is a simplified view of FIG. 1. A network N₁ constructed through the human account 11 that is the default account of the user terminal A and a network N₂ constructed through the interest account 12 of the user terminal A are networked independently from each other. In addition, an overlapping area may exist therebetween. Users corresponding to the overlapping area are in a humanly close friend relationship and an interest thereof is common. In other words, since people in the friend relationship in an existing social network have the common interest, information (including commercial information) and content related to the interest in addition to routinely shared news may be actively exchanged.

Various kinds of information may be diffused through the network N₁ by human closeness and information related to the common interest may be diffused through the network N₂. The networks N₁ and N₂ may be developed to have different characteristics.

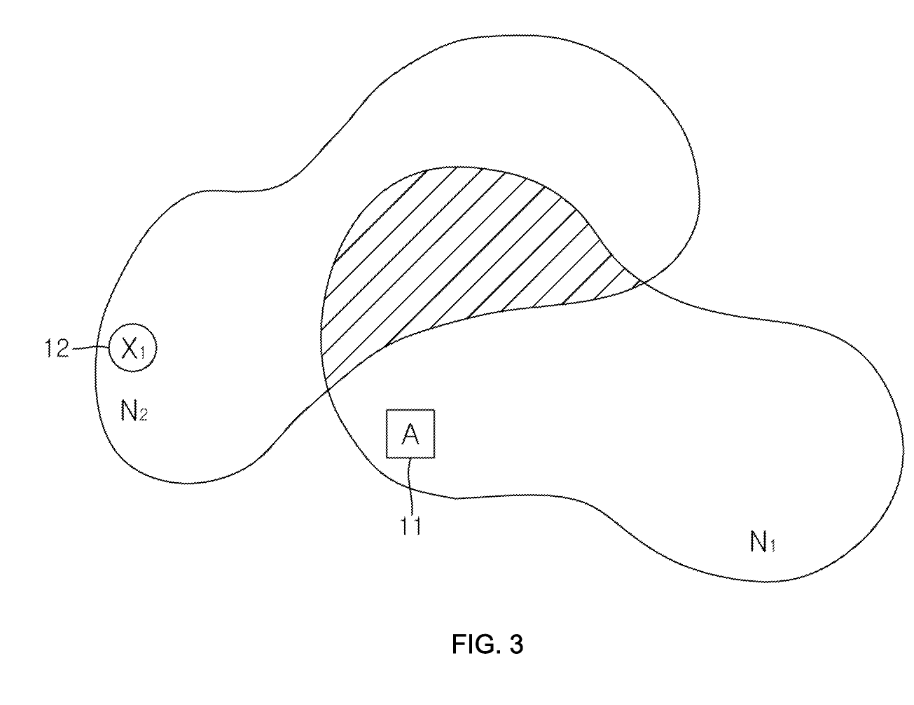

FIG. 3 schematically illustrates a configuration of a system for realizing such a networking method. The platform server 5 operates and manages the network platform 1 in which a human account and an interest account are dualized. The platform server 5 constructs various databases for operating a network according to an embodiment of the present disclosure. The database 3 may store resources that are uploaded, shared, and diffused in the network N₁. The database 4 may store resources that are uploaded, shared, and diffused in the network N₂. Besides, other various databases may be added. As the databases, there is a user information database, keyword database, category database, content database, or log database, etc. In addition, the platform server 5 includes software necessary for networking, data processing and transmission, communication, management, or security, etc.

When a user terminal P 100 accesses the platform 1, the user account 10 formed of multi-accounts may be selectively used. Log-in may be performed using the human account 11 that is the default account, and also using any one of the interest accounts 12, 13, and 14. Other user terminals Q₁ and Q₂ may access this platform 1. The user terminal Q₁ 200 may be networked with the user terminal P 100 through the network N₁ of the human account 11. On the other hand, the user terminal Q₂ 300 is networked, to the network N₂ through the interest account 34 of its own, with the user terminal P 100 that accesses the platform 1 through the interest account 12 identical to or associated with the interest account 34. The platform server 5 may provide information on another user terminal Q (not shown) having the interest accounts 12, 13, and 14 that are registered in the user terminal P 100.

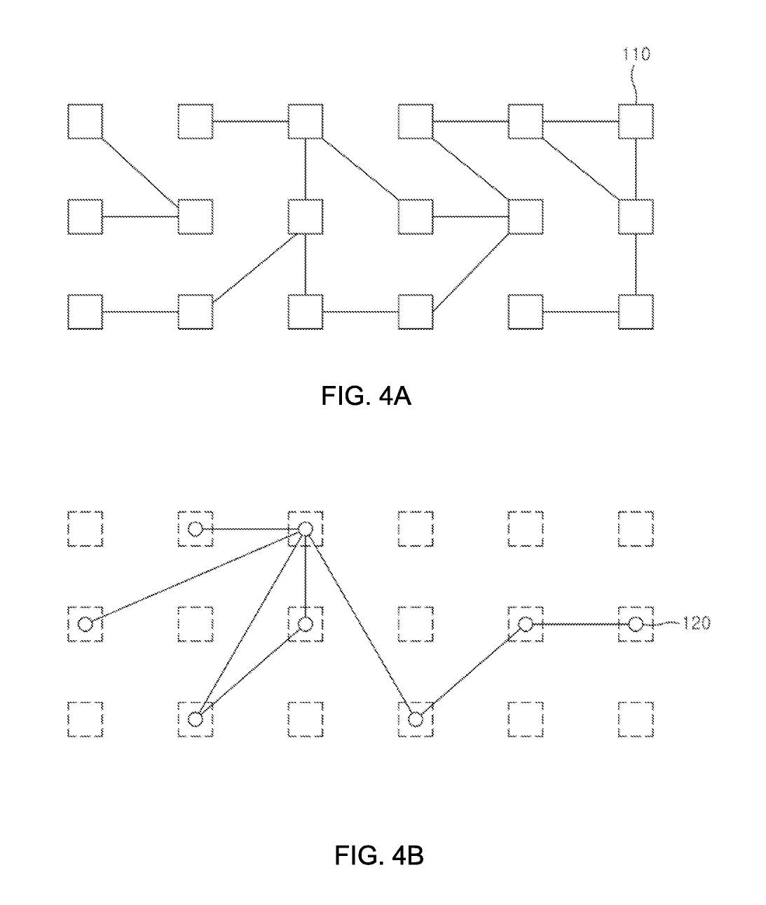

Referring to FIGS. 4A and 4B, FIG. 4A schematically illustrates mutual networking through the human accounts by the user terminals 110 that are registered in a social network of the present disclosure. However, as separately illustrated in FIG. 4B, there exist user terminals 120 mutually networking through the interest accounts. FIGS. 4A and 4B illustrate that the two networks are separately dualized.

Then, what is the interest account? The interest account in the present disclosure is a unique ID newly generated by the user terminal that has logged in through a human account, and the user terminal registers “an interest subject” and “an ID” using letters and/or numbers. A type of the interest subject does not limit the protection scope of the present disclosure. The interest subject may be a name of an object (or product) or service. In addition, the interest subject may include something unspecified that may be specified with letters and/or numbers from among politics, economy, academy, history, figure, area, culture, entertainment, sport, business, content, and technology. The interest account may be deleted and in this case, the deletion does not affect other interest accounts or the human account.

When an upload event to the platform 1 is performed through the interest account, the upload event is diffused to other user terminals set through interest accounts. However, the upload event is not diffused to user terminals that are not in a friend relationship by a corresponding interest account but in a friend relationship by a human account. On the other hand, when the upload event to the platform 1 is performed through the human account, the upload event is diffused to user terminals that are in a friend relationship by the human account.

The upload event for uploading to the platform is as the following (the upload event does not particularly depend on the interest account or human account).

(1) uploading text to a page of a user terminal: the user terminal may access a platform through a human account or interest account to upload the text. Then the text is diffused to other user terminals that are networked through a corresponding account.

(2) uploading a still image or video to a page of a user terminal: the user terminal may access a platform through a human account or interest account to upload a photo or the video. Then the photo or video is diffused to other user terminals that are networked through a corresponding account.

(3) uploading a response action of a user terminal with respect to information that is networked: the user terminal may write a comment or upload a response such as “like” with respect to information that is uploaded to the platform by another user terminal being in a fried relationship. In addition, a network to which this response action is diffused varies according to which account is used to log in.

(4) uploading a link of an article located on another network to a page of the user terminal P: that the user terminal posts a link to a page thereof is a representative upload event of the SNS. A network to which this event is diffused varies according to which account is used to log in.

(5) updating registration information on the user terminal P: means an event, for example, for changing a default profile photo of a user, or changing personal information.

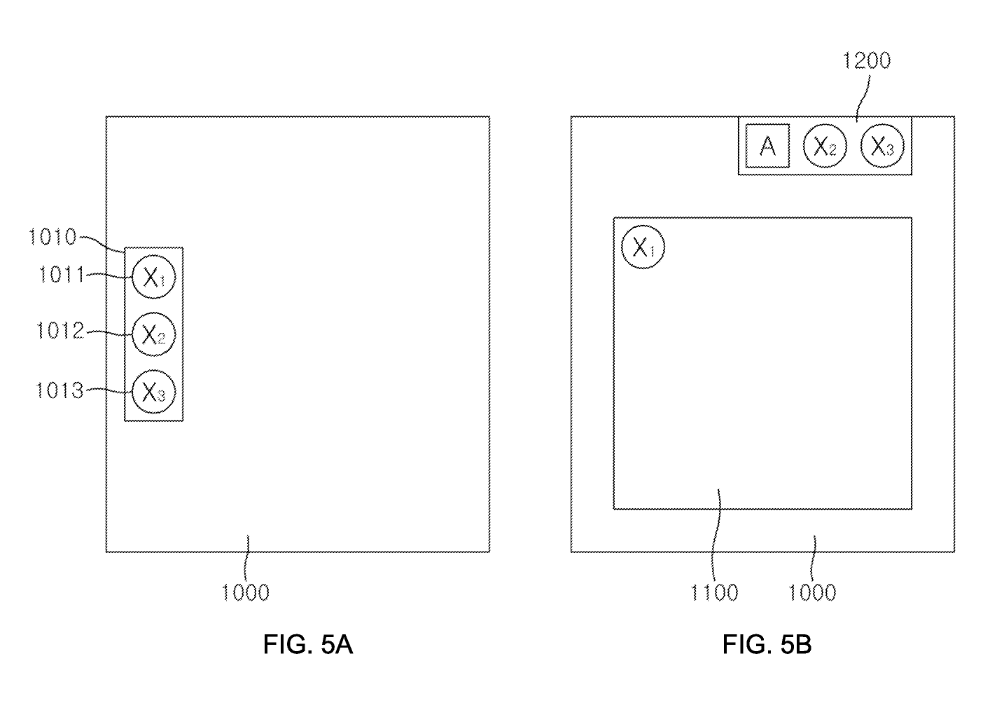

FIGS. 5A and 5B schematically illustrate exemplary screen configurations of a user page 1000 according to an embodiment of the present disclosure. FIG. 5A illustrates the configuration of the user page 1000 in a case of logging in through the human account. In the case of logging in through the human account, the user page 1000 of the user terminal may include all networking information on the human and interest accounts. This is because the human account is the default account. For example, a list of interest accounts 1011, 1012, and 1013 may be displayed on an interest account area 1010.

On the other hand, in the case of logging in through the interest account, the user page 1000 of the user terminal may include only networking information on a corresponding interest account. An interest account page 1100 includes only information diffused in relation to a corresponding interest and an account may be changed by selecting an area 1200 on which another interest account or human account is displayed.

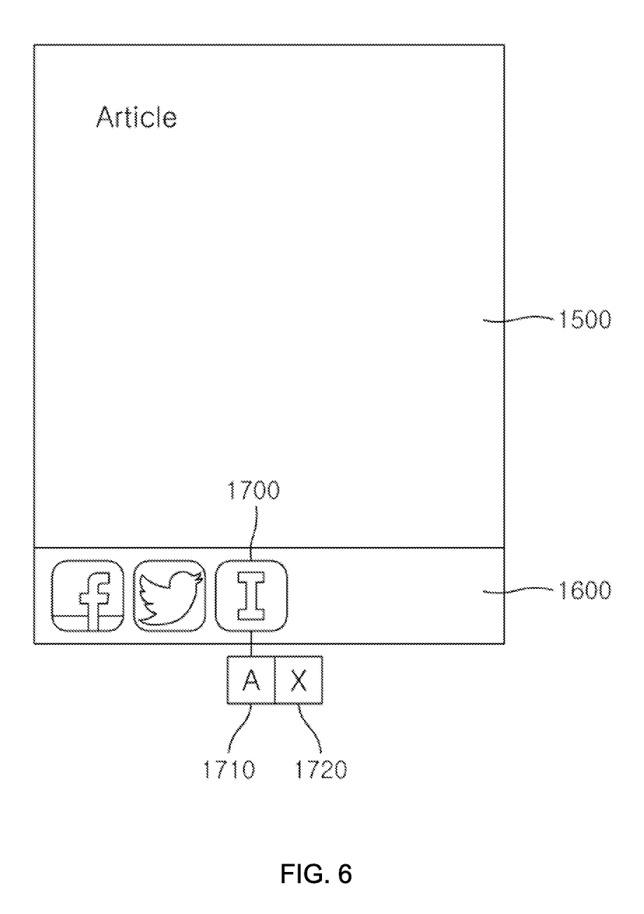

FIG. 6 illustrates an embodiment in which information on another network is brought to a network of the present disclosure. In particular, the network of the present disclosure may be called using an application programming interface (API) technique from another network that is not the network of the present disclosure. For example, let us assume that there is an API identifier 1700 according to the present disclosure in an API-SNS area 1600 that is in a bottom portion of a newspaper article page 1500 (that is not limited to the newspaper but is sufficient to call the network of the present disclosure using the API) existing in another network. Since the networks of the present disclosure are dualized through the human and interest accounts, when the user terminal selects the API identifier 1700, a human account identifier 1710 and an interest account identifier 1720 may be displayed. By selecting these, it may be determined whether the link is uploaded to the network N₁ or a corresponding link is uploaded to the network N₂.

Furthermore, when a user terminal generates an interest account, letters and/or numbers are input as a keyword (i.e. title of an interest subject) and in the present disclosure, a platform server may present, to the user terminal, one or more recommended interest keywords associated with the input interest keyword.

At this point, a category to which the keyword belongs is presented therewith to distinguish the keyword from homophonic keywords.

At this point, in the case where the user terminal selects one of recommended interest keywords, the platform server may simply register the selected recommended interest keyword as a new interest account. The recommended interest keyword may be presented with reference to a keyword registered as an interest account of another user terminal that is in a friend relationship with the user terminal through a human account. In addition, among many similar interest keywords registered in the platform, an interest keyword that is most associated with the interest keyword input by the user terminal is calculated and presented as the recommended interest keyword. The number of interest keywords registered as the interest account may be referred to. This is for allowing the interest subject not to be extremely subdivided.

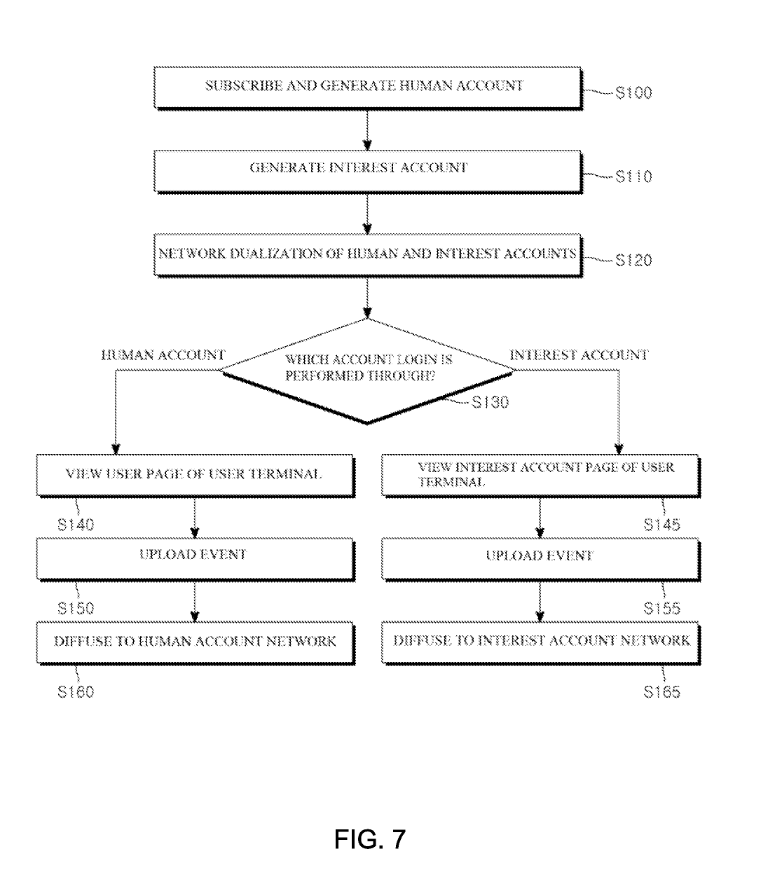

FIG. 7 schematically illustrates an overall process of the above-described method of the present disclosure. There is an SNS platform according to an embodiment of the present disclosure. In addition, many user terminals will connect to this platform to carry out networking.

First, a certain user terminal subscribes to this platform and generates a unique human account as a default account (operation S100). Furthermore, log-in to the platform is performed through this human account and social networking is carried out. It is assumed that this human account is “skynsea”.

Next, it is assumed that a user is interested in “European soccer” and wants to share information on the European soccer and have a personal relationship with people enjoying the European soccer. Then, a user terminal of the user registers (for example) “European soccer” as an interest subject and additionally generates a unique account with an ID of (for example) “iloveEPL” for the interest subject (operation S110). In this way, a corresponding user terminal becomes to hold multi accounts.

For social-networking this user terminal, a platform server carries out networking such as relationship generation and information sharing with the interest account “iloveEPL” for the “European soccer”, separately from existing networking that is carried out through the human account “skynsea” (operation S120).

In an embodiment, when the user terminal completes generation of the interest account in operation S110, for smooth networking through the interest account, the platform server may present information on another user terminal (a user terminal being in a friend relationship by a human account or not) that has registered interests identical to or associated with the interest account, such as “Champions league”, “Premier league”, and “Spain league” as well as “European league”, as interest subjects. The association may be registered in the platform database in advance.

Network dualization and a resultant output to a terminal screen of a user page may vary according to which account the platform is accessed through (operation S130). When the platform is accessed by logging in through a human account, a default user page of the user terminal is output to the screen (operation S140). In addition, when an upload event is executed on this user page (operation S150), the upload event may be diffused to other user terminals being in a friendship relation by the human account (operation S160).

When the platform is accessed by logging in through an account of “iloveEPL”, an interest account page of “European soccer” is output to a screen of the user terminal (operation S145). In addition, when an upload event is executed on this user page (operation S155), the upload event is diffused among people being interested in the European soccer (operation S165).

### VARIOUS APPLICATION EXAMPLES

1. As described above, since a network by a human account and a network by an interest account are separately exist in the network dualization according to an embodiment of the present disclosure, information pushed by a platform server may also be divided and pushed through the human account and interest account. Unlike the human account, the interest account allows a user to feel less uncomfortable, even when commercial content associated with the interest is pushed. For example, when an interest account is generated by adopting “smartphone application” as an interest subject, since networking is carried out among people being interested in the smartphone application, promotion content pertaining to a newly released smartphone application may be effectively pushed to the interest accounts of terminals of those people.

2. In an embodiment described above, although a diffusions range of an upload event is explained according to whether an access or login procedure is executed through the human account or interest account, this is for effectively explaining the dualized network of the present disclosure. During the upload event, the user terminal may determine which network the uploaded information is diffused to. At this point, whether to diffuse information through a human account or an interest account may be determined and according to the determination, a platform server provides an SNS.

According to embodiments of the present disclosure, not only a human account, which is a default account, but an interest account is also allowed to be a unique account and accordingly a social network is structured with multiple accounts. In other words, according to embodiments of the present invention, a new network may be constructed among users who have a common interest using an interest account. Up to now, the social network has excessively depended on human relations. That has a meaning in its own way, but the present disclosure is advantageous in that networking is carried out by adopting a common interest as a new connection link while maintaining an existing network despite of none of human relations. In addition, information on the common interest may be actively exchanged and furthermore the information may be efficiently diffused in the network.

In a network tied through the interest account, since it is not a people-centric network but an interest-centric network, it is natural to achieve an industrial effect that when the interest is focused, accurate customer targeting is possible. In addition, commercial information may be prevented from being abused and wasted. In other words, it is possible to lay the foundation stone of evolution from a social network to a social business platform by using a system and method of the present disclosure.

Furthermore, since being associated with an existing user account, the interest account may be managed in an integrated manner with the user account without a need for separately managing it. This may allow users to conveniently access two different network environments and may contribute to vitalization of a new network through improvement in convenience and accessibility.

The effects of the present disclosure are not limited to the above mentioned effects, and other effects not mentioned above may be clearly understood through technical features of the present disclosure.

In relation to drawings of the present disclosure, the respective blocks may illustrate parts of modules, segments or codes including at least one or more executable instructions for performing specific logic function(s). Moreover, it should be noted that the functions mentioned in the blocks may occur out of order in some alternative examples. For example, two blocks successively illustrated blocks may be performed substantially at the same time, or may be performed in reverse order according to their functions. The drawings are enlarged or exaggerated for convenience of explanation.

In addition, the protection scope of the present disclosure is not limited to the description and the expression of explicitly explained examples above. Further, it will be understood that the protection scope of the present disclosure is not limited by obvious modifications or substitutions in the technical fields of the present disclosure.

1-8. (canceled)

9. A method of providing a social network service in which an interest account and a human account are dualized, the method performed by a platform server and comprising:
(a) receiving, from a user terminal P logging in the social network service through a human account, a request for generating an interest account, wherein the interest account sets up a friend relationship separated from that of the human account;
(b) providing different networking resources to the user terminal P by separating the human account from the interest account; and
(c-1) in response to an activity by the user terminal P through the interest account, informing the activity through the interest account to another user terminal Q2 of which friend relationship is set through the interest account; or
(c-2) in response to an activity by the user terminal P through the human account, informing the activity through the human account to another user terminal Q1 of which friend relationship is set through the human account.

10. The method of claim 1, further comprising:
allowing the user terminal P to selectively log in through any one of the human account and the interest account.

11. The method of claim 2, wherein, if the user terminal P logs in through the human account, providing a first user page comprising both of networking information on the human account and networking information on the interest account, and
if the user terminal P logs in through the interest account, providing a second user page of the user terminal P comprising networking information on the interest account.

12. The method of claim 1, further comprising, in response to receiving the request for generating the interest account:
receiving an interest keyword from the user terminal P; and
presenting one or more recommended interest keywords associated with the received interest keyword.

13. The method of claim 4, further comprising, after the interest account is generated for the user terminal P:
presenting information on a user terminal Q1 that has interest accounts covering an interest identical to or associated with the interest account of the user terminal P.

14. The method of claim 1, wherein operation (b) comprises performing a call for an application programming interface (API) while distinguishing the human account from the interest account.

15. The method of claim 1, wherein the activity includes:
(1) uploading text to a page of the user terminal P;
(2) uploading a still image or video to a page of the user terminal P;
(3) uploading a response action on networking information on the user terminal P;
(4) uploading to link an article located in another network to the user terminal P; or
(5) updating registered information on the user terminal P.

16. The method of claim 1, further comprising: pushing, one or more pieces of information from the platform to the user terminal such that pushing operations for the human account and the interest account are performed separately from each other.
